(19) United States
(12) Patent Application Publication
(10) Pub. No.: US 2006/0001806 A1
(43) Pub. Date: Jan. 5, 2006

(54) Liquid crystal display device

(76) Inventors: Kee-Han Uh, Yongin-si (KR); Jin-Oh Kwag, Suwon-si (KR); Jin-Hyuk Yun, Seoul (KR)

Correspondence Address: CANTOR COLBURN, LLP, 55 GRIFFIN ROAD SOUTH, BLOOMFIELD, CT, 06002, US

(21) Appl. No.: 11/157,623

(22) Filed: Jun. 21, 2005

(30) Foreign Application Priority Data
Jun. 21, 2004 (KR) 10-2004-0046131

(51) Int. Cl. G02F 1/1335

(52) U.S. Cl. 349/114

(57) ABSTRACT

A display device having dual displaying faces comprises a liquid crystal display panel, a light emitting unit and a light guide plate. The liquid crystal display panel is provided with a first substrate having a transmitting electrode and a reflecting electrode, a second substrate facing the first substrate with a gap disposed between the first and second substrates and a liquid crystal layer disposed in the gap. The second substrate has a common electrode. The light emitting unit is disposed on the second substrate. The light emitting unit has a lamp for emitting light. The light guide plate transfers light emitted by the lamp to the liquid crystal display panel.

This application claims priority to Korean Patent Application No. 2004-0046131 filed on Jun. 21, 2004, and all the benefits accruing therefrom under 35 U.S.C §119, and the contents of which in its entirety are herein incorporated by reference.

### BACKGROUND OF THE INVENTION

(a) Field of the Invention

The present disclosure relates to a liquid crystal display device.

(b) Description of the Related Art

A liquid crystal display (“LCD”) device is a widely used example of a flat panel display device. An LCD device includes a lower panel and an upper panel having field-generating electrodes and a liquid crystal layer interposed between the lower and upper panels. The lower and upper panels along with the liquid crystal layer form a display panel of the LCD device. In order to display images, the LCD device controls a transmittance of light passing through the liquid crystal layer by realigning liquid crystal molecules disposed in the liquid crystal layer with voltages applied to the field-generating electrodes.

LCD devices are generally equipped with the lower and upper panels each having field-generating electrodes. Among widely used LCD device structures, pixel electrodes are typically arranged in a matrix form at the lower panel and one common electrode covers an entire surface of the upper panel. An image display of the LCD device is achieved by applying a voltage to each pixel electrode. In order to apply voltages to the pixel electrodes, a thin film transistor (TFT) for switching the voltages applied to the pixel electrodes is electrically connected to each pixel electrode. Also, a gate line for transmitting a signal to control the TFT and a data line for transmitting the voltages applied to pixel electrodes are installed at the display panel.

Depending on a light source employed, i.e. using a backlight or ambient light, LCD devices can be classified into different categories including, for example, a transmissive LCD device, a reflective LCD device and a transflective LCD device integrating a reflective mode and a transmissive mode.

Recently, a dual LCD device displaying images on both sides has been proposed. The dual LCD device, which is provided with a main liquid crystal display panel and a sub liquid crystal display panel, respectively, displays images on both sides.

However, the dual LCD device has problems in that although the main liquid crystal display panel and the sub liquid crystal display panel are installed at one LCD device, a backlight has to be installed for each of the main and sub liquid crystal display panels, thereby increasing a thickness, weight and power consumption of the dual LCD device.

### SUMMARY OF THE INVENTION

A liquid crystal display device according to the present invention comprises a liquid crystal display panel, a light emitting unit and a light guide plate. The liquid crystal display panel is provided with a first substrate having a transmitting electrode and a reflecting electrode, a second substrate facing the first substrate with a gap disposed between the first and second substrates, and a liquid crystal layer disposed in the gap. The second substrate has a common electrode. The light emitting unit is disposed on the second substrate. The light emitting unit includes a lamp emitting light. The light guide plate transfers light emitted by the lamp to the liquid crystal display panel.

A display device is also provided that includes a first substrate, a second substrate, a liquid crystal layer and a light unit. The first substrate is disposed at a main window side of the display device. The second substrate is disposed opposite to the first substrate with respect to a gap between the first and second substrates. The second substrate is disposed at a sub window side of the display device. The liquid crystal layer is disposed in the gap. The light unit is disposed proximate to only one of the first and second substrates. The display device displays images at both the main window side and sub window side using light from the light unit.

### BRIEF DESCRIPTION OF THE DRAWINGS

FIG. 1 is a sectional view of a transflective type liquid crystal display device according to an exemplary embodiment of the present invention; and

FIG. 2 is a sectional view illustrating in details a lower substrate of FIG. 1.

### DETAILED DESCRIPTION OF THE INVENTION

The present invention provides a dual liquid crystal display device, which uses a single liquid crystal display panel to display images on both sides of the liquid crystal display device.

Exemplary embodiments of the present invention will be described more fully hereinafter with reference to the accompanying drawings, in which exemplary embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, thicknesses of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

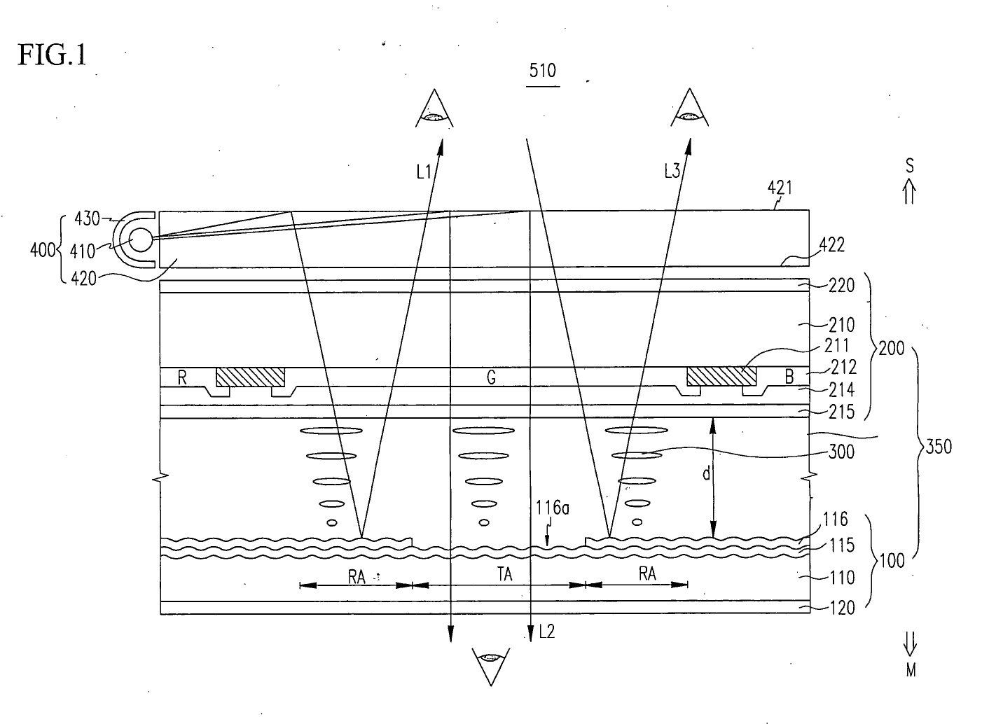

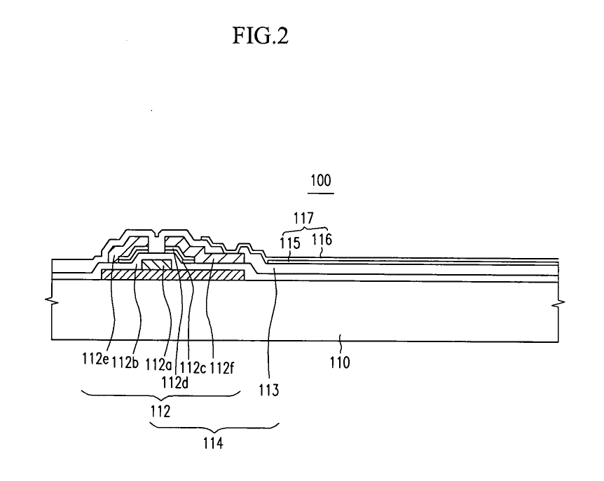

FIG. 1 is a sectional view of a transflective type liquid crystal display (LCD) device according to an exemplary embodiment of the present invention, and FIG. 2 is a sectional view illustrating in detail a lower substrate of FIG. 1.

As shown in FIG. 1, a transflective type LCD device 510 (hereinafter referred to as “LCD device”) according to an exemplary embodiment of the present invention includes a light emitting unit 400 emitting a first light L1 and a second light L2, and an LCD panel 350, which is disposed proximate to an internal side of the light emitting unit 400. The LCD device 510 displays images using the first light L1, the second light L2, or a third light L3 supplied from an exterior of the LCD device 510.

The LCD panel 350 is provided with an upper substrate 200, a lower substrate 100 facing the upper substrate 200, and a liquid crystal layer 300 disposed in a gap between the upper substrate 200 and the lower substrate 100. The gap has a predetermined width d.

A first polarizing plate 120, which is disposed on a lower part of the lower substrate 100, polarizes the second light L2 emitted from the light emitting unit 400 which has passed through the liquid crystal layer 300 of the LCD panel 350.

A second polarizing plate 220 disposed on an upper part of the upper substrate 200, polarizes the first light L1 and the third light L3. The first light L1 is emitted from the light emitting unit 400, reflected by a reflecting electrode and projected back through a portion of the light emitting unit 400.

The light emitting unit 400 is disposed on the LCD panel 350 and includes a lamp 410 emitting light and a light guide plate 420 transferring the first and second lights L1 and L2 projected from the lamp 410 to the LCD panel 350.

The lamp 410 is surrounded on three sides by a reflective plate 430 that focuses the first and second lights L1 and L2 projected from the lamp 410 onto the light guide plate 420.

As shown in FIG. 1 and FIG. 2, the lower substrate 100 includes a first substrate 110, a thin film transistor (TFT) array 114 disposed on the first substrate 110, and a pixel electrode 117 disposed on the TFT array 114.

The TFT array 114 includes a TFT 112 and a first protective layer 113 protecting the TFT 112. The TFT 112 is formed of a gate electrode 112a, a gate insulating layer 112b, an active layer 112c, an ohmic contact layer 112d, a source electrode 112e and a drain electrode 112f.

The gate electrode 112a is provided corresponding to a light shielding layer 211 disposed at a portion of a second substrate 210 of the upper substrate 200. The gate insulating layer 112b is disposed on an entire surface of the first substrate 110 including where the gate electrode 112a is disposed.

The active layer 112c and the ohmic contact layer 112d are disposed on a portion of the gate insulating layer 112b corresponding to the gate electrode 112a. The source electrode 112e and the drain electrode 112f are provided on the ohmic contact layer 112d and are spaced apart from each other at a certain distance.

In addition to the gate electrode 112a, the source and drain electrodes 112e and 112f are also disposed corresponding to an area at which the light shielding layer 211 is disposed. Thus, the light shielding layer 211 protects the first and third lights L1 and L3 from being reflected by the gate electrode 112a, the source electrode 112e and the drain electrode 112f.

The first protective layer 113 disposed on the TFT 112 partially exposes the drain electrode 112f of the TFT 112. The pixel electrode 117, which is disposed on the first protective layer 113 and an exposed portion of the drain electrode 112f, is electrically connected to the drain electrode 112f.

The pixel electrode 117 is formed from a reflecting electrode 116 and a transmitting electrode 115. The transmitting electrode 115 is made of, for example, indium tin oxide (ITO) or indium zinc oxide (IZO). The reflecting electrode 116 is made of a metal such as Aluminum-Neodymium (AlNd), is disposed on the transmitting electrode 115 and is connected to a portion of the drain electrode 112f.

The reflecting electrode 116 has a transmitting window 116a, which is a portion of the pixel electrode 117 where only the reflecting electrode 115 exists. The transmitting window 116a divides the lower substrate 100 into a reflection region RA corresponding to the portion of the pixel electrode where only the reflecting electrode 115 exists and a transmission region TA corresponding to a portion of the pixel electrode 117 where both the transmitting electrode 115 and the reflecting electrode exist. The reflecting electrode 116 is embossed to include lenses disposed in a pattern to increase a reflectivity of the first light L1 and the third light L3.

The liquid crystal layer 300 is formed of, for example, twisted nematic liquid crystal.

The light shielding layer 211 and a color filter layer 212 are disposed on the upper substrate 210, and a second protective layer 214 is disposed on the light shielding layer 211 and the color filter layer 212.

The color filter layer 212 has red, green and blue color pixels (R, G and B), which are spaced apart from each other by a predetermined distance. The light shielding layer 211, which is provided among the color pixels R, G and B, fixes boundaries of a region where each color pixel is formed, thereby improving color reappearance of each color pixel. The second protective layer 214 made of a photocrosslinkable material, is disposed on the color filter layer 212 and protects the color filter layer 212.

A common electrode 215 is disposed on the second protective layer 214. The common electrode 215 is made of a transparent conductive material and is disposed on the second protective layer 214 in a uniform thickness.

A portion of the second light L2 emitted by the lamp 410 is reflected by an outer surface 421 of the light guide plate, and is projected through an inner surface of the light guide plate 422 and toward a main-window side indicated generally by arrow M through the liquid crystal layer 300 of the LCD panel 350 and the transmitting electrode 115, thereby allowing a display of images at a first side (i.e. the main window side M) of the LCD device 510. In other words, the LCD device 510 operates in a transmissive mode.

A portion of the first light L1 emitted from the lamp 410 is reflected by the outer surface 421 of the light guide plate, passes through the liquid crystal layer 300 of the LCD panel 350, and is reflected by the reflecting electrode 116. Then, the portion of the first light L1 passes through the light guide plate 420 and is projected to the exterior of the LCD device 510 toward a sub-window side indicated generally by arrow S, thereby allowing a display of images at a second side (i.e. the sub window side S) of the LCD device 510. In other words, the LCD device 510 operates in a first reflective mode. The first reflective mode is preferably applied when the exterior is dark.

The third light L3 passes through the light guide plate 420, is reflected by the reflecting electrode 116 of the LCD panel 350, passes through the light guide plate 420 again, and is projected to the exterior of the LCD device 510 toward the sub-window side S, thereby allowing the display of images at the second side of the LCD device 510. In other words, the LCD device 510 operates in a second reflective mode, which is preferably applied when the exterior is bright.

As explained the above, the outer surface 421 of the light guide plate 420 reflects the first and second lights L1 and L2 emitted from the lamp 410, transmits the third light L3 in an incident direction, and transmits the first and third lights L1 and L3 reflected by the reflecting electrode 116 of the lower substrate 100 in an exiting direction.

Therefore, the sub window side S of the LCD panel 350 seen from the second of the LCD device 510 is used as a sub-window and, the main window side M of the LCD panel 350 seen from the first of the LCD device 510 is used as a main-window.

Thus, the main window side M of a single transflective LCD panel 350 is used in a transmissive mode and the sub window side S is used in a reflective mode, so that both sides of the LCD panel 350 may be used to display images.

The present invention provides a dual liquid crystal display device, which uses a single liquid crystal display panel and a single light emitting unit, thereby reducing thickness and weight of the liquid crystal display device while minimizing power consumption.

Although exemplary embodiments have been described herein with reference to the accompanying drawings, it is to be understood that the present invention is not limited to those precise embodiments, and that various changes and modifications may be affected therein by one of ordinary skill in the related art without departing from the scope or spirit of the invention. All such changes and modifications are intended to be included within the scope of the invention as defined by the appended claims.

What is claimed is:

1. A display device having dual displaying faces comprising:
a liquid crystal display panel including a first substrate having a transmitting electrode and a reflecting electrode, a second substrate facing the first substrate with a gap between the first and second substrates and having a common electrode, and a liquid crystal layer disposed in the gap;
a light emitting unit disposed on the second substrate and having a lamp for emitting light; and
a light guide plate for transferring light emitted by the lamp to the liquid crystal display panel.

2. The display device of claim 1, wherein a portion of the light emitted by the lamp is reflected by the light guide plate, and is projected to an exterior of the first substrate through the transmitting electrode of the liquid crystal display panel.

3. The display device of claim 1, wherein a portion of the light emitted by the lamp is reflected by the light guide plate toward the reflecting electrode, and is reflected by the reflecting electrode back toward the light guide plate, and is projected to an exterior of the display device through the light guide plate, and wherein the reflecting electrode has an embossed surface.

4. The display device of claim 3, wherein the embossed surface comprises a pattern of lenses.

5. The display device of claim 1, wherein external light introduced into the liquid crystal panel through the light guide plate is reflected by the reflecting electrode of the liquid crystal display panel and is projected toward an exterior of the second substrate through the light guide plate.

6. The display device of claim 1, wherein an outer surface of the light guide plate reflects the light emitted from the lamp, transmits external light, and transmits light reflected by the reflecting electrode of the first substrate.

7. The display device of claim 1, wherein a first side of the liquid crystal display panel seen from an outside of the light guide plate is used as a sub-window, a second side of the liquid crystal display panel seen from an outside of the first substrate is used as a main-window.

8. The display device of claim 1, wherein the light guide plate is disposed on an outer surface of the second substrate.

9. The display device of claim 7, further comprising
a first polarizing plate disposed on an outer surface of the first substrate; and
a second polarizing plate disposed between the light guide plate and the second substrate.

10. A display device comprising:
a first substrate disposed at a main window side of the display device;
a second substrate disposed at a sub window side of the display device, the second substrate disposed opposite to the first substrate with respect to a gap disposed between the first and second substrates;
a liquid crystal layer disposed in the gap; and
a light unit disposed proximate to only one of the first and second substrates,
wherein the display device displays images at both the sub window side and the main window side using light from the light unit.

11. The display device of claim 10, wherein the display device displays images at the sub window side in a reflective mode.

12. The display device of claim 11, wherein light is reflected by a reflecting electrode portion of a pixel electrode disposed on the first substrate.

13. The display device of claim 11, wherein the display device displays images at the sub window side in the reflective mode using reflected light from the light unit.

14. The display device of claim 11, wherein the display device displays images at the sub window side in the reflective mode using externally provided light.

15. The display device of claim 10, wherein the display device displays images at the main window side in a transmissive mode.

16. The display device of claim 15, wherein the light unit provides light to the main window side by directing the light through a transmissive window of a pixel electrode disposed on the first substrate.

17. The display device of claim 10, wherein the first substrate includes a pixel electrode having a reflecting portion and a transmissive portion.

18. The display device of claim 17, wherein the reflecting portion comprises a reflecting electrode and a transmitting electrode, and the transmissive portion comprises the transmitting electrode.

19. The display device of claim 10, wherein the light unit comprises:
a light source; and
a light guide plate.

20. The display device of claim 19, wherein the light guide plate is disposed at the second substrate.
